(19) United States
(12) Patent Application Publication
(10) Pub. No.: US 2024/0066828 A1
(43) Pub. Date: Feb. 29, 2024

(54) Composite Deployable Into Structure

(71) Applicant: United States of America as represented by the Administrator of NASA, Washington, DC (US)

(72) Inventors: Jin Ho Kang, Newport News, VA (US); Keith L. Gordon, Hampton, VA (US); Shella Ann Thibeault, Hampton, VA (US); Jeffrey A. Hinkley, Yorktown, VA (US)

(21) Appl. No.: 18/238,137

(22) Filed: Aug. 25, 2023

Related U.S. Application Data
(60) Provisional application No. 63/455,468, filed on Mar. 29, 2023.
(60) Provisional application No. 63/452,752, filed on Mar. 17, 2023.
(60) Provisional application No. 63/401,394, filed on Aug. 26, 2022.

(51) Int. Cl. B32B 3/08; B32B 5/02; B32B 9/00; B32B 9/04; B32B 27/08; B32B 27/12; B32B 27/38

(52) U.S. Cl. CPC B32B 3/085; B32B 5/02; B32B 9/005; B32B 9/045; B32B 27/08; B32B 27/12; B32B 27/38; B32B 2260/021; B32B 2260/046; B32B 2307/7376

(57) ABSTRACT

A composite material may include a polymer resin layer; and a plurality of rigid plates to reinforce the polymer resin layer, each rigid plate of the plurality of rigid plates having a polygon shape with rigid sides. The plurality of rigid plates may be fabricated in a pattern in the polymer resin layer to form a plurality of hinges in the polymer resin layer between sides of the plurality of rigid plates, so that the composite is foldable at the plurality of hinges into a collapse state and expandable at the plurality of hinges to deploy into a structure.

### CROSS-REFERENCE TO RELATED PATENT APPLICATION(S)

This patent application claims the benefit of and priority to U.S. provisional application No. 63/401,394, filed on Aug. 26, 2022, and U.S. provisional application No. 63/452,752, filed on Mar. 17, 2023, and U.S. provisional application No. 63/455,468, filed on Mar. 29, 2023, the contents of all of which are hereby incorporated by reference in their entirety.

### STATEMENT REGARDING FEDERALLY SPONSORED RESEARCH OR DEVELOPMENT

The embodiments of the invention described herein were made by employees of the United States Government and may be manufactured and used by or for the Government of the United States of America for governmental purposes without the payment of any royalties thereon or therefore.

### BACKGROUND OF THE INVENTION

FIG. 21A is a diagram of the state-of-the-art space structures 900, including an inflatable decelerator, a solar sail, a composite collapsible tubular mast boom, and inflatable habitat on legs. Foldable (also may be referred to as Origami) based structures may be constructed to be inflatable using inflating gas to be deployed.

Due to the confined volume of standardized space launch vehicle cargos, large space structures may be needed to be packed in a small volume and footprint before launch and to be deployed, for example, be inflated into original structures at the mission location. Deployable composite tubular booms have been known for lightweight structures. The known deployable composite tubular booms may have several limitations, because while the known composite tubular booms may consist of a thin layer composite to be an excellent lightweight system to hold relatively low mass payload, such as solar sail or solar array, however, a buckling load of the known composite tubular boom may not be high enough for load bearing applications in structures like surface habitats or payload transferring systems.

Inflatable structures have been widely used for space applications, but an inflatable structure needs for a continuous gas supplement to replace slow leakage of inflatable gas or to adjust the temperature induced pressure change, with its attendant additional weight and shortened service life. In addition, high kinetic energy micrometeoroids in space which may reach a speed of 20 kilometers per second can cause a catastrophic failure, for example, by puncturing the thin layer composite of the inflatable structure.

FIG. 21B is a diagram of a known origami-based habitat in which the panels of the origami structure may be under tension through mechanical spring biased hinges in a stowed state and deployable when relieving the tension. Therefore, the habitat may be stowed by applying force, and the legs, poles, of the habitat may not be collapsible or may be telescoping for a stowed state of the legs.

FIG. 21C is a diagram of a known triangular rollable and collapsible (TRAC)-spring guided hinge. However, the TRAC-spring guided hinges may require a constant force to be maintained in a collapsed state.

### BRIEF SUMMARY OF THE INVENTION

The described embodiments of present invention relate to deployable and rigidize-able composites (compositions) for structures that can bear a load, for example, space structures to be deployed in outer space, mission locations (for example, on earth, on an astronomical body) in outer space.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 is a diagram of an origami-based deployable structure, according to an example;

FIG. 2 is a diagram of a cross-section of a composite material, according to an example;

FIG. 3 is a diagram of a process to shape a composite material, according to an example;

FIG. 4 is a diagram of a process to shape a composite material, according to another example;

FIG. 5 is a diagram of a process to shape a composite material, according to another example;

FIG. 6 is a line graph of dynamic mechanical property of carbon fiber reinforced shape memory polymer composites, according to examples;

FIG. 7A is a plot graph of glass transition of an SMP;

FIG. 7B is a graph of dynamic mechanical property of carbon fiber reinforced shape memory polymer (SMP) composites;

FIG. 7C is a graph of shape memory effect of carbon reinforced shape memory polymer (SMP) composites;

FIG. 8 is a diagram illustrating a process of curing a composite made of a UV curable polymer, according to an example;

FIGS. 9-10 are line graphs of curing characteristics of a UV curable polymer, according to an example;

FIG. 11 is a diagram of models of patterns of origami structures using a composite, according to the described examples;

FIG. 12 is a diagram to compare the state-of-the-art telescoping beam versus an origami-based beam structure using a composite according the described examples.

FIG. 13A is a diagram of material characteristics of the state-of-the-art pipe used as a beam in a structure shown in FIG. 13B;

FIG. 13B is a diagram of examples of applications of a composite according to the described examples, deployed into state-of-the-art structures;

FIG. 13C is a diagram of material comparison between the state-of-the-art pipe used as a beam in a structure shown in FIG. 13B versus a composite according to the described examples, by finite element analysis (FEA) model;

FIGS. 14-17 are comparisons of material conditions of the state-of-the-art beam structure versus a beam made of a composite according to the described examples;

FIG. 18 is a diagram of a fabrication process of a composite, according to an example;

FIG. 19 is a diagram of a polyhedron pattern structure 105 made of a composite according to an example, in a collapsed state and subsequent deployed state;

FIG. 20 is a diagram of examples of application of a composite according to the described examples, deployed into state-of-the-art structures;

FIG. 21A is a diagram of the state-of-the-art space structures;

FIG. 21B is a diagram of a state-of-the-art origami based habitat;

FIG. 21C is a diagram of a state of the art triangular rollable and collapsible (TRAC)-spring guided hinge.

### DETAILED DESCRIPTION OF THE INVENTION

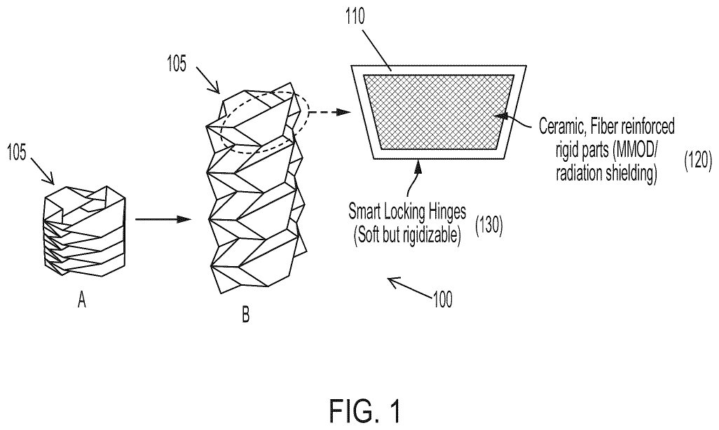

FIG. 1 is a diagram of an origami-based deployable structure, according to an example. FIG. 1 illustrates a composite material (may be referred to a ‘composite’) 100 in form of a foldable (origami-based) polyhedron pattern structure 105 in a stowed state (A), and in a deployed state (B) which is a cylinder shape. The polyhedron pattern structure 105 may include a polymer-based resin layer 110 with polygon shaped tiles 120, which are rigid plates, fabricated in the polymer-based resin layer 110 to form a three-dimensional polyhedron structure 105 made of the composite 100. The polygon shaped tiles 120 of the structure may be fiber reinforced rigid parts. In an example, the polygon shaped tiles 120 may provide micrometeoroid debris (MMOD) and/or radiation shielding. A spacing area between the polygon shaped tiles 120 may function as hinges 130 (may correspond to a crease in an origami structure) between the polygon shaped tiles 120. The hinges 130 may be made of the polymer-based resin layer 110, resulting in the hinges 130 having elastic and stiffness characteristics by being soft but rigidize-able and being ductile in response to an external stimulus. In an example, the external stimulus may be force and/or heat. However, other examples of stimulus many be at least one stimulus among heat, force, electric and magnetic field, water and light. In an example, the polyhedron pattern structure 105 may be a rigid, bidirectionally foldable cylinder which is tiled. Such foldable, space-filling cylinders may open the possibility of constructing cellular materials based on the polygon shaped tiles 120 with a rigid folding and deploying mechanism.

The polyhedron pattern structure 105 may have a polyhedron three-dimensional shape with polygon shaped tiles 120. In an example, the polygon shaped tiles 120 may be any polygon shape from among quadrilaterals and triangles. In an example, the polygon shaped tiles 120 may be arranged in a pattern of a set of skew quadrilaterals with each quadrilateral composed from two planar triangles.

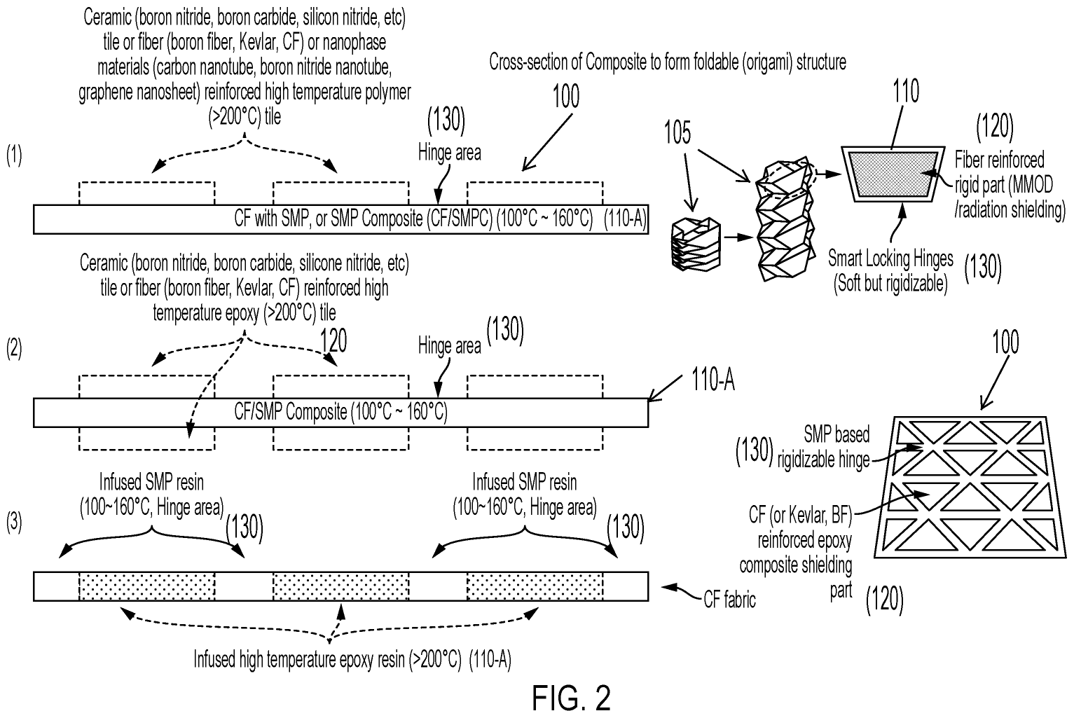

FIG. 2 is a diagram of a cross-section of a composite material, according to an example. In FIG. 2, the composite material 100 may include a polymer-based resin layer 110 with polygon shaped tiles 120 fabricated in the polymer-based resin layer 110. In an example, the polymer-based resin layer 110 may be a shape memory polymer (SMP) 110-A composite. In an example, the SMP 110-A may be fiber reinforced, for example, with carbon fiber (CF). In example (1), the polygon shaped tiles 120 may be fabricated by way of stenciling, installing, or embedding, the polygon shaped tiles 120 on upper side of the polymer-based resin layer 110, in example (2) the polygon shaped tiles 120 may be fabricated on upper side and/or lower side (both sides of) the polymer-based resin layer 110, and in example (3), the polygon shaped tiles 120 may be fabricated by way of infusion of the polymer-based resin layer 110 in a pattern area, or spacings, among the polygon shaped tiles 120, resulting in forming spacing areas that function as the hinge 130.

In an example, the polygon shaped tiles 120 may be made of ceramic material from among boron nitride, boron carbide, and silicon nitride, and/or may be made of polymer (epoxy, bismaleimide, cyanate ester, polyimide) reinforced with fiber material from among boron fiber (BF), KEVLAR and carbon fiber (CF), carbon nanotube (CNT), boron nitride nanotube (BNNT), graphene nanosheet (GNS) resulting in a fiber reinforced epoxy shielding part of the composite material 100. In an example, a rigid plate of the plurality of rigid plates may include epoxy reinforced with at least one fiber material from among boron fiber (BF), KEVLAR, carbon fiber (CF), and a hybrid fiber of boron and polyamide. In an example, a rigid plate of the plurality of rigid plates includes epoxy reinforced with at least one fiber material from among aramid fiber, boron fiber, glass fiber, polyethylene fiber and metal fiber. In an example, the at least one fiber material is in at least one form, from among forms, of a weaved fabric form, a non-woven fabric form, and unidirectional fibers form.

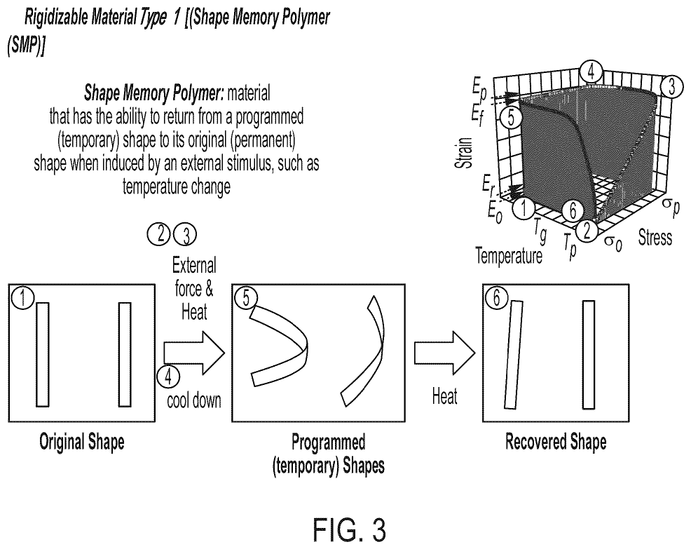

FIG. 3 is a diagram of a process to shape a composite material, according to an example. In an example, the composite material 100 may SMP, which at stage 1 is in an original shape. At stages 2 and 3, external stimulus such as force and heat may be applied to the SMP 110-A to shape the SMP 110-A, resulting after a cool down stage 4 in a shape at stage 5 that may be a stowed shape as a programmed shape. In an example, at deployment stage 6 after applying heat, the original shape of the SMP 110-A may be recovered. Advantageously, force may not be required to recover the original shape for deployment. In an example, a transition from the original shape of the composite material 100 to effectuate a shape change as a programmed shape of the composite material 100 may be induced by a stimulus, or triggered upon occurrence of a stimulus such as temperature change, electric or magnetic field.

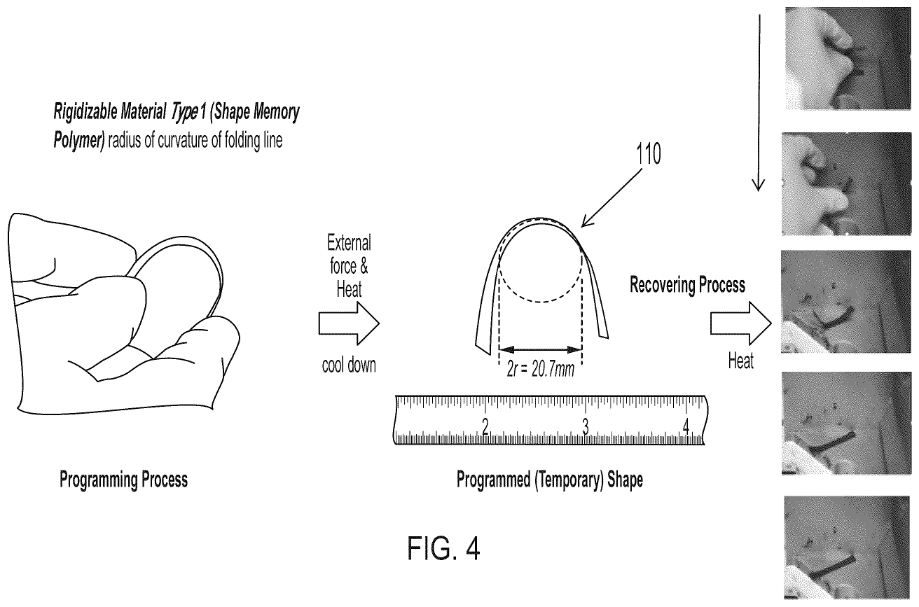

FIG. 4 is a diagram of a process to shape a composite material, according to another example. In FIG. 4, a piece of the SMP 110-A is illustrated for explanation convenience. At stage 1, the SMP 110-A in form of a flat layer may be subjected to stress and heat, resulting in a shape change of the SMP 110-A to an arc shaped layer with a diameter of 2r being 20.7 millimeters (mm). In an example, a temperature change may induce a shape change to the original shape as a recovered shape.

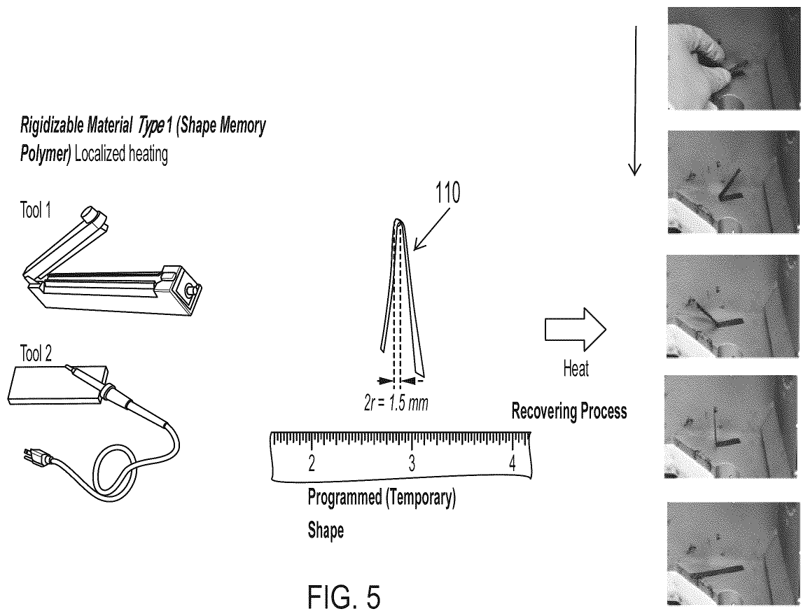

FIG. 5 is a diagram of a process to shape a composite material, according to another example. In FIG. 5, a piece of the SMP 110-A is illustrated for explanation convenience. At stage 1, the SMP 110-A in form of a flat layer may be subjected to stress and heat, resulting in a shape change of the SMP 110-A to an arc shaped layer with a diameter of 2r being 1.5 millimeters (mm). In an example, a temperature change may induce a shape change to return to the original shape as a recovered shape.

According to an example, materials of the composite material 100 may be shape reconfigurable for packaging by folding (origami) pattern, and may deploy and self-rigidize without supplementary inflating gas. A origami-based deployable structure may include soft (but rigidizable) hinges 130 at spaced areas between the polygon shaped tiles 120 which are rigid plates. In an example of a space structure, the polygon shaped tiles 120 may be for structural integrity and shielding against MMOD and/or radiation in outer space. In an example, the approach to fabricate the polymer-based resin layer 110 into the deployable composite may include: (1) creating an origami pattern, (2) providing rigid plates in an origami pattern in a soft and rigidize-able polymer resin (may also be referred to as shape memory polymer (SMP) for structural integrity of the polymer resin, resulting in (3) the polymer resin functioning as hinges (may also be referred to as ‘smart hinges’) at the spaced areas between sides of the rigid plates. The hinges formed the polymer resin the being capable of transitioning into a soft state for folding and—unfolding, and capable of transitioning into a rigid state in folded and unfolded states. In an example, origami based deployable and rigidizable composite can be used for load bearing structure for inflatable habitat, deployable space structure and other deployable structures for military applications.

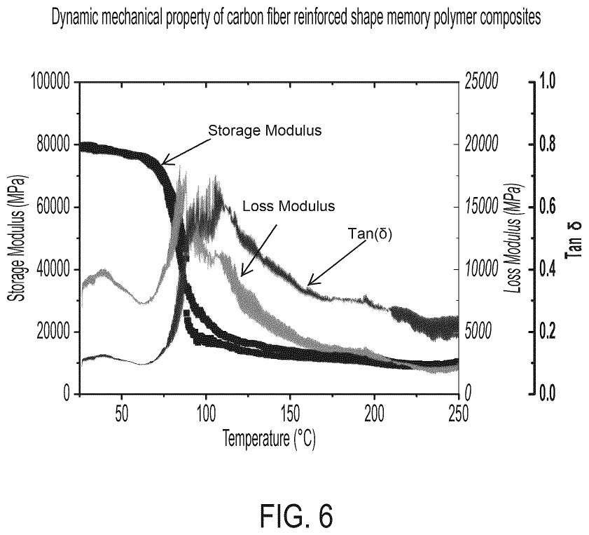

FIG. 6 is a line graph of dynamic mechanical property of carbon fiber (plain weave, [0/90]₂) reinforced shape memory polymer (SMP) composites, according to described examples. In FIG. 6, storage modulus in MegaPascal (MPa) versus Temperature (Celsius (° C.)) ranges versus loss modulus (MPa) and Tan delta (δ) (Tangent of Delta) are indicated. As indicated in FIG. 6, storage modulus at room temperature was about 70 Gigapascal (GPa) and decreased to about 20 GPa above glass transition temperature of about 93° C. The loss modulus at room temperature was about 30 GPa, peaked to about 70 GPa at glass transition temperature of about 93° C., and decreased to about 15 GPa from above the glass transition temperature. The glass transition temperature was about 100° C. for a Tan 6 peak which is a ratio of loss modulus over storage modulus.

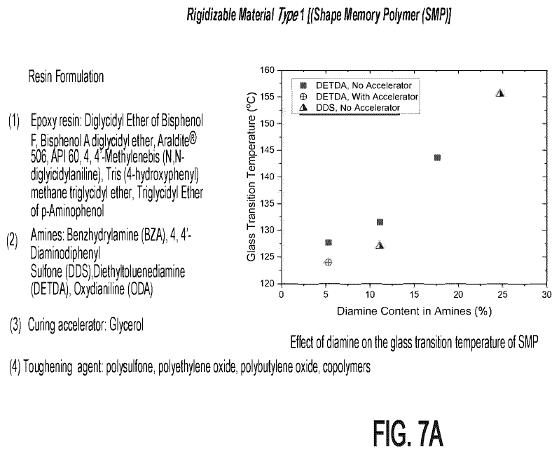

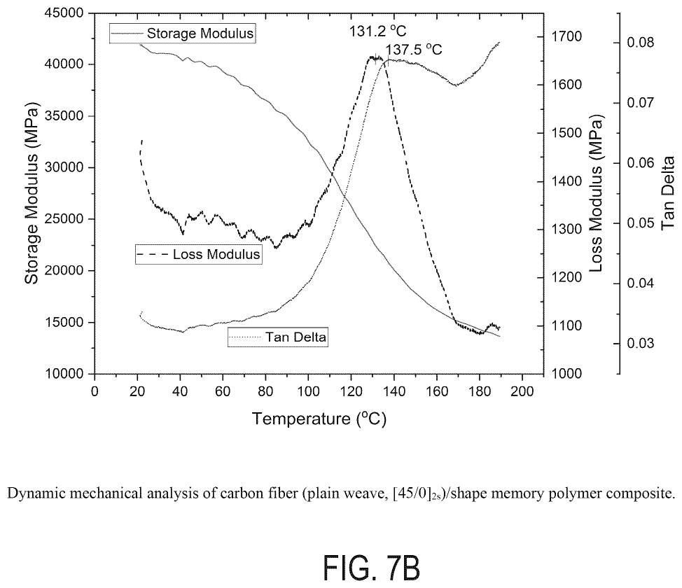

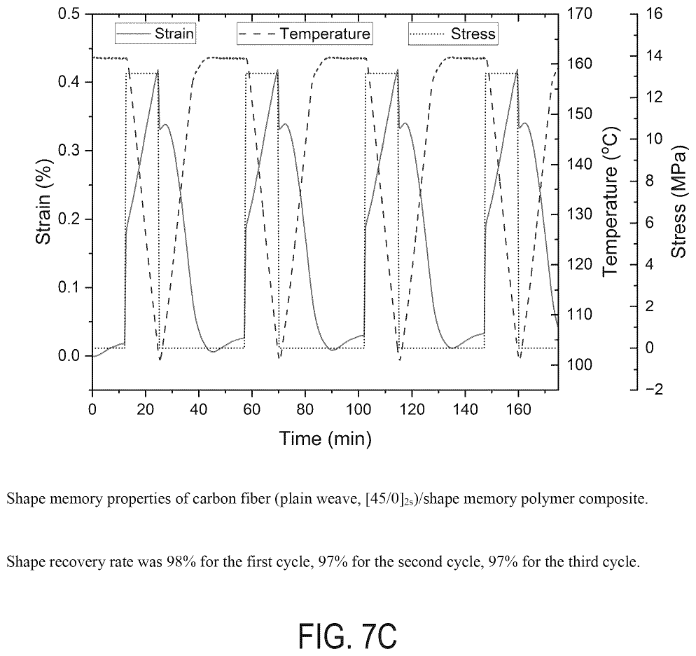

FIG. 7 is a plot graph of glass transition of an SMP, according to an example. In an example, the SMP may be an epoxy resin that may be selected from a group of epoxy resins including diglycidyl Ether of Bisphenol F; Bisphenol A diglycidyl ether; ARALDITE®-506; API 60, 4,4′-Mehylenebis(N,N-diglyicidylaniline), Tris(4-hydroxyphenyl)methane triglycidyl ether, Triglycidyl Ether of p-Aminophenol or mixed epoxy, with at least one amine from among monoamine, Benzhydrylamine (BZA); diamine, 4, 4′-Diaminodiphenyl Sulfone (DDS), Diethyltoluenediamine (DETDA), and Oxydianiline (ODA). In an example, the group of epoxy resins may further include Trifunctional epoxy; Triglycidyl Ether of p-Aminophenol; Tris(4-hydroxyphenyl)methane triglycidyl ether; Tetrafunctional epoxy; 4,4′-Methylenebis[N,N-bis(2,3-epoxypropyl)aniline], or mixed epoxy. In an example, a curing accelerator may be used, such as glycerol. The FIG. 7 graph shows the effect of diamine content in percentage of the SMP on the glass transition temperature of the SMP. As may be observed from FIG. 7, the diamine content of about 5% with or without an accelerator, respectively, may result in a glass transition temperature range of the SMP 110-A to be about 122° C. to 127° C., which is within a range of about 100° C. to 150° C. for activating shaping. In an example, the diamine content is about 1% to about 99%, preferably about 5% to about 20%, in molar concentration of total amines of monoamine and diamine.

In an example, the glass transition of the SMP 110-A may be tailored by the ratio of amines and curing conditions. As molar concentration of diamine (diethyltoluenediamine n amine mixture (diethyltoluenediamine and benzyhydrylamine) increased from 5.3% to 18%, glass transition temperature increased from about 128 to about 144° C. In addition, as molar concentration of diamine (4,4′-Diaminodiphenyl Sulfone) in amine mixture (4,4′-Diaminodiphenyl Sulfone and benzyhydrylamine) increased from 11% to 25% glass transition temperature increased from about 127 to about 156° C.

In addition, when the cure accelerator (glycerin, 3 phr) was added, the glass transition temperature decreased by about 4° C. In an example, the thermally induced shape memory polymer can be prepared by crosslinking control of amine-cured [4 4′-methylenebis(N,N′-)diglycidylaniline]-based epoxy or biphenyl-tetracarboxylic acid-based imides with cross linking end cappers. Acrylated epoxy resin with photoinitiator such as sulfonium cationic photoinitiator may be cured with a UV LED lamp array in the origami structures.

In an example, a composite material may include a polymer resin layer; and a plurality of rigid plates to reinforce the polymer resin layer, each rigid plate of the plurality of rigid plates having a polygon shape with rigid sides, the plurality of rigid plates fabricated in a pattern in the polymer resin layer to form a plurality of hinges in the polymer resin layer between sides of the plurality of rigid plates, so that the composite is foldable at the plurality of hinges into a collapse state and expandable at the plurality of hinges to deploy into a structure. In an example, the polymer resin layer may be a shape memory polymer (SMP) 110-A made of epoxy resin and at least one amine. A shaping temperature of the SMP 110-A may result from a determinable ratio of the epoxy resin and the at least one amine. In an example, a shaping temperature of the SMP 110-A may be about 100˜160 degree ° C. (approximately between 100 to 160° C.). In an example, the epoxy resin may be at least one epoxy resin, or a mixture of epoxy resins, from a group of epoxy resins including diglycidyl Ether of Bisphenol F; Bisphenol A diglycidyl ether; ARALDITE 506; and API 60, with the at least one amine from among Benzhydrylamine; 4, 4′-Diaminodiphenyl Sulfone, Diethyltoluenediamine, and Oxydianiline. In an example, the group of epoxy resins may further include Trifunctional epoxy; Triglycidyl Ether of p-Aminophenol; Tris(4-hydroxyphenyl)methane triglycidyl ether; Tetrafunctional epoxy; 4,4′-Methylenebis[N,N-bis(2,3-epoxypropyl)aniline].

FIG. 7B is a graph of dynamic mechanical property of carbon fiber (plain weave, [45/0]_{2S}) reinforced shape memory polymer (SMP) composites prepared with 3 phr accelerator, according to described examples. As indicated in FIG. 7B, storage modulus at room temperature was about 45 Gigapascal (GPa) and decreased to about 50 GPa above glass transition temperature of about 137° C. The loss modulus at room temperature was about 30 GPa, peaked to about 40 GPa at glass transition temperature of about 131° C., and decreased to about 15 GPa from above the glass transition temperature. The glass transition temperature was about 137° C. for a Tan 6 peak which is a ratio of loss modulus over storage modulus.

FIG. 7C is a graph of shape memory effect of carbon fiber (plain weave, [45/0]2S) reinforced shape memory polymer (SMP) composites. Sample was heated above glass transition temperature, 161° C., and applied with a load of 131 MPa to change the shape. The change strain was about 0.42% with a load. And it was cooled down below its glass transition temperature, 101° C. to fix the shape change. The fixed strain after unload was 0.33%. To return original shape, the sample was heated again above glass transition temperature, and the recovery shape rate was 98%. The test was repeated for 10 cycles and the second and third recovery shape rate kept about 97%. To minimize thermal expansion contribution from the shape memory effect, sample was preheated above glass transition temperature and cool down to 100° C. before start.

In an example, the polymer resin layer may be an ultraviolet (UV) curable polymer 110-B made of bisphenol-A epoxy diacrylate cured with about 20% by weight of a crosslinker among crosslinkers consisting of pentaerythritol tetraacrylyate, and pentaerythritol triacrylate. In an example, a UV curable polymer 110-B may initially be in a soft uncured state and may be curable into a rigid state, for example, by being cross-linked by a photo-initiator and reactive monomers under UV radiation, and may provide a sufficiently permanent rigidity for locking function of an origami structure 105.

In an example, the SMP 110-A or UV curable polymer 110-B may have a thickness between about 0.070 mm to about 50 mm.

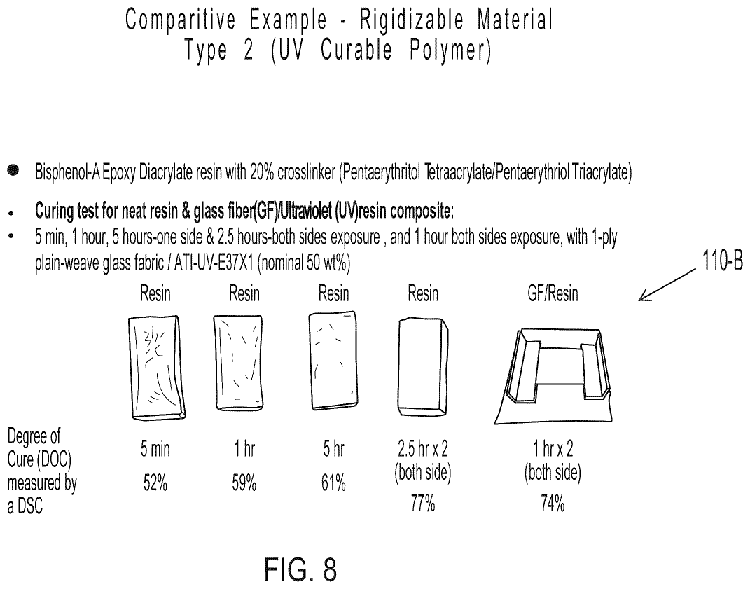

FIG. 8 is a diagram illustrating test results of curing a composite made of a UV curable polymer resin, according to an example. In an example, the UV curable polymer 110-B may be Bisphenol-A Epoxy Diacrylate resin, for example, ATI-UV-E37X1 by ADHERENT TECHNOLOGIES, INC., with a 20% crosslinker from among Pentaerythritol, Tetraacrylate, Pentaerythritol Triacrylate may be used. In FIG. 8, test results of curing a 1-ply plain-weave glass fabric/ATI-UV-E37X1 (nominal 50 weight (wt) %) using a solar simulator of 1 sun and an air mass (AMO) filter for UV exposure times of 5 minutes (min); 1 hour (hr); 5 hr; 2.5 hr×2 (both sides); and 1 hr×2 (both sides), resulted in respective degree of cure (DOC) measured by a Differential Scanning calorimetry (DSC) instrument of 52%, 59%, 77% and 74%. Curing both sides may reduce stickiness of the UV curable polymer resin. The curing degree of the UV curable polymer resin was increased with increase in duration of UV exposure, so that while the UV curable polymer resin may not be fully cured after 5 hours of exposure to UV, it is apparent that a longer than 5 hours of UV exposure may result in a 100% cured resin. In an example, in a vacuum, the curing degree may reach about 100%. In an example, a curing degree may be about 90% so that the UV curable polymer 110-b does not become too brittle. In an example, the curing results of a samples of the UV curable polymer resin may be analyzed based on using Thermogravimetric Analysis (TGA) instruments, Fourier Transform Infrared Spectroscopy (FTIR) instruments.

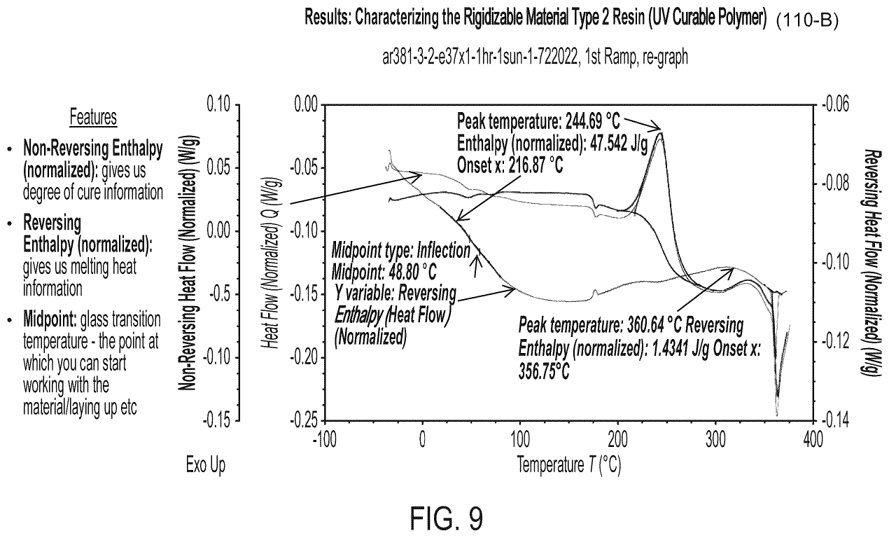

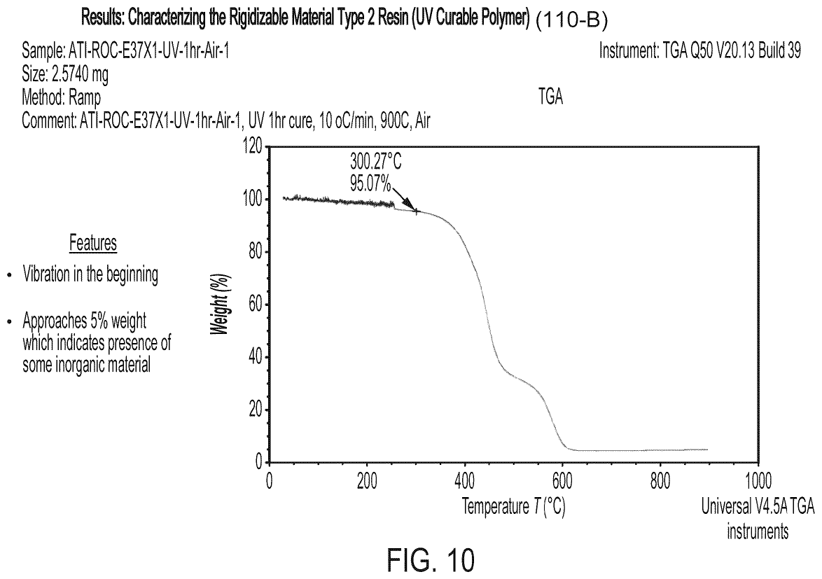

FIGS. 9-10 are line graphs of curing characteristics of a UV curable polymer, according to an example. The graphs in FIGS. 9-10 indicate curing parameters for the UV curable polymer 110-B. According to FIG. 9, about 48.80° C. may be a glass transition temperature to work with the UV curable polymer 110-B and about 360.4° C. may be melting heat point. The non-reversing enthalpy and the reversing enthalpy may determine heat flow. FIG. 9 demonstrates the heat flow and resulting enthalpy in form of degree of curing to be targeted while UV may be applied, so that the UV curable polymer 110-B can transition from a soft state to a rigid state when deploying an origami-based structure 105 made of the UV curable polymer 110-B. In FIG. 9, the peak temperature of 244.9° C. for 1 hour indicates a curing enthalpy of 47.542 Joule/gram(g) versus in FIG. 8, 1 hour of curing provided a 59% degree of cure. The curing enthalpy may be checked by an instrument to determine whether a target rigidity has been reached.

According to FIG. 8, the curing enthalpy of the UV curable polymer 110-B may reach 77%. In an example, the curing enthalpy in a vacuum may approach about 100% (for example, 90%). In FIG. 10, a weight of the UV curable polymer may be 95.07% at a temperature of about 300.27° C., reflecting a 5% weight in inorganic materials. In an example, the glass transition temperature (Tg) may be around 93° C., and the cure enthalpy should decrease as the curing time in heat simulation, for example, solar exposure simulation increases.

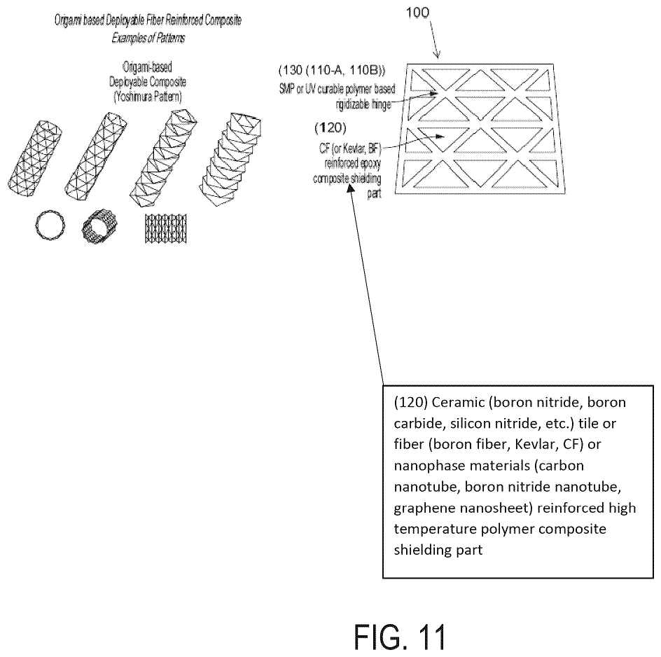

FIG. 11 is a diagram of models of patterns of origami structures using a composite, according to the described examples. In an example, an origami pattern-based beam may adopt the Yoshimura pattern, or the Kresling pattern.

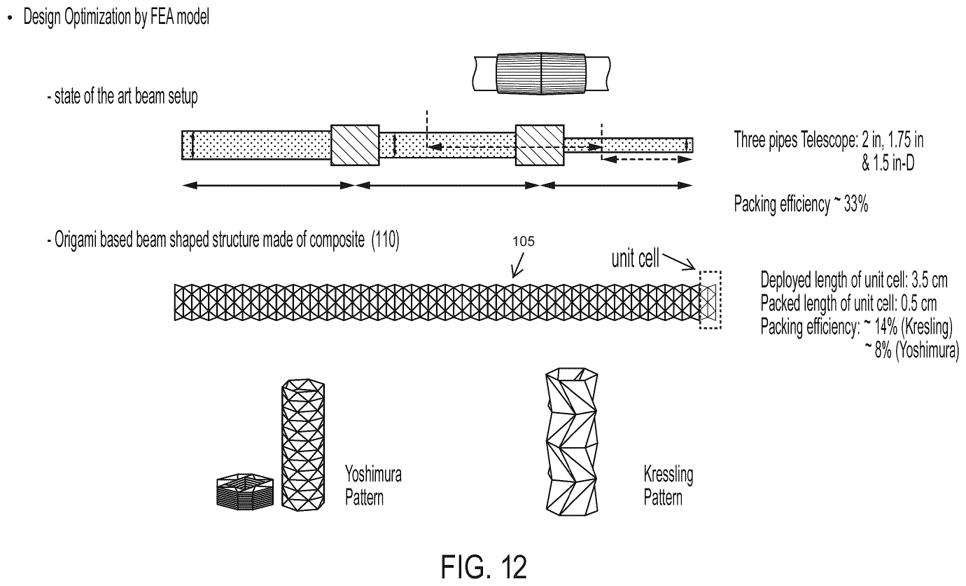

FIG. 12 is a diagram to compare the state-of-the-art telescoping beam versus an origami-based beam structure using a composite according the described examples. The state-of-the-art telescoping beam may be a Polyvinyl Chloride (PVC) pipe. As illustrated in FIG. 12, a packing efficiency into a collapsed state for the telescoping beam may be 33% while a packing efficiency into a collapses state of an origami-based beam structure using a composite according to the described examples is between about 8% to about 14% depending on the origami pattern.

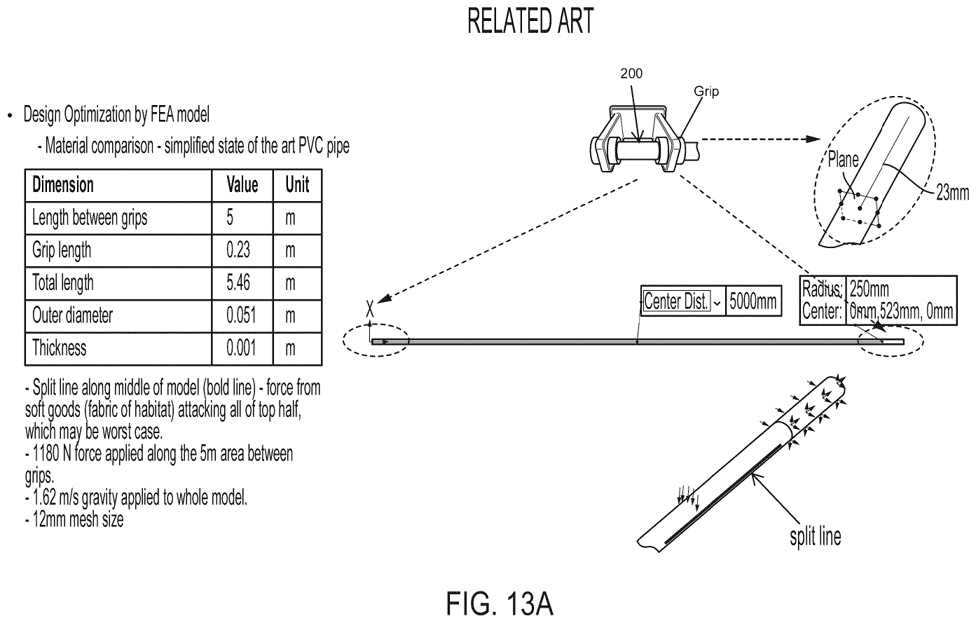

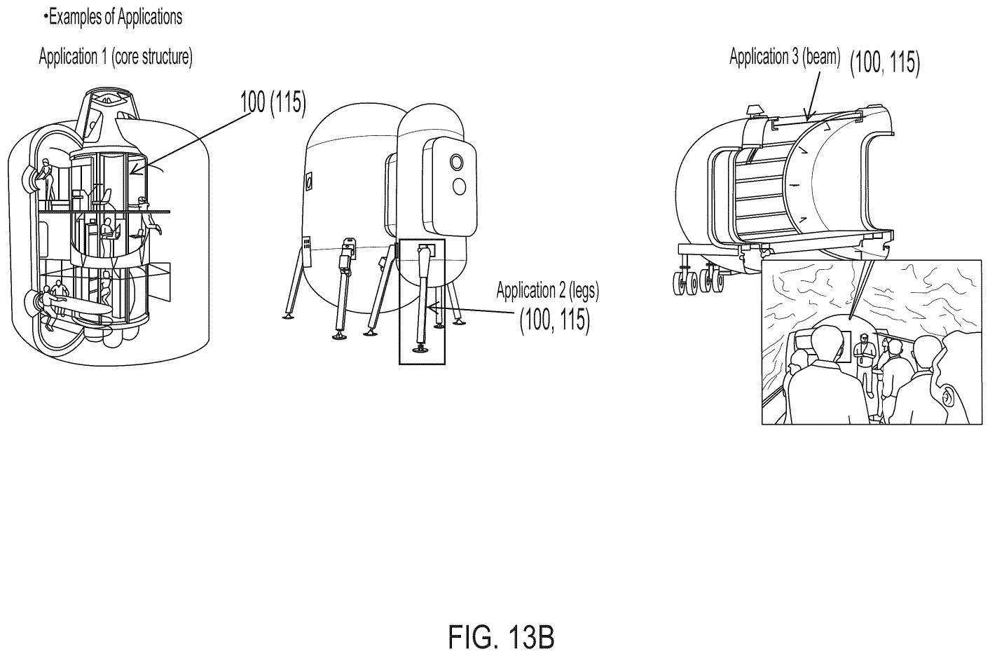

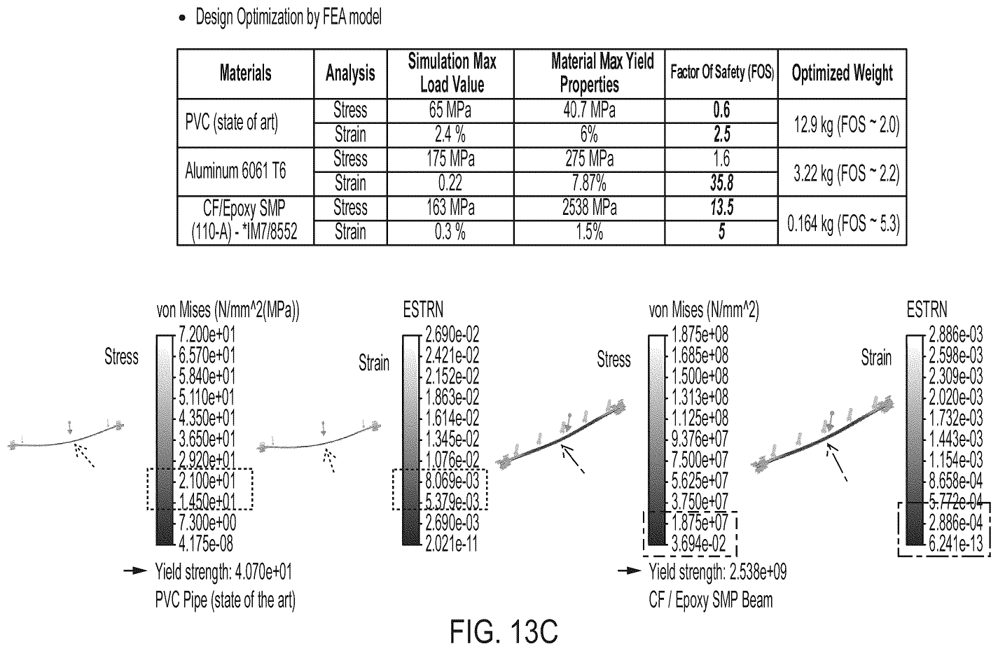

FIG. 13A is a diagram of material characteristics of the state of the art pipe used as a beam in a structure shown in FIG. 13B. FIG. 13A shows material characteristics of the state of the art PVC pipe material in an example use case, such as application (3) (beam) in FIG. 13B, when subjected to 1180 N (newton) force applied along the 5 m area between grips holding the PVC pipe when used as a beam in a habitat structure as illustrate in FIG. 13B.

FIG. 13B is a diagram of examples of applications of a composite according to the described examples, deployed into state-of-the-art structures. In FIG. 13B, some examples of applications of a composite 100 when deployed into a structure may be a core structure beam 115 of a habitat, a leg beam 115 of a raised habitat, or a load bearing beam 115 inside and/or outside a habitat. In an example, referring to FIG. 13B, in the state-of-the-art beams are installed after deployment of a structure (referred to as expansion in case of the state-of-the-art inflatable structure), such a habitat deployment. Advantageously, according to the composite 100 in the present disclosure, origami based beam shaped structures 105 may be deployed together with deployment of a structure, such as habitat deployment, without supplementary inflating gas but in response to a stimulus, for example, heat, to activate a shape change in the polymer-based resin layer 110 of the composite 100, resulting in a recovery of a shape of the polymer-based resin layer 110 of the composite 100 from a stowed state to a deployed state.

FIG. 13C is a diagram of material comparison between the state-of-the-art pipe used as a beam in a structure shown in FIG. 13B versus a composite according to the described examples, by finite element analysis (FEA) model. In case of a habitat structure, an origami-based beam shaped structure 105 may need to hold its own weight plus the weight of a heat blanket (soft fabric) in form of downward forces and a restraint layer, to avoid sagging in the beam 105. In an example, FIG. 13C, show results of analysis of material original or max yield properties in form of von Mises stress, simulation of maximum load in von Mises stress, FOS, and optimized weight, when an origami-based beam shaped structure 105 may be subjected to stress and strain in comparison to the state of the art PVC and Aluminum 6061-T6 hollow cylinders. As indicated in FIG. 13C, in an example, for an origami-based beam shaped structure 105 under the simulated max load value of 163 MPa and strain of 3% at the optimized weight of 0.164 kg, the FOS is well above 2 at 13.5 and 5 for stress and strain, respectively. When load in form of von Mises stress and equivalent strain (ESTRN) are applied, an origami-based beam shaped structure 105 does not bend or sag as much when compared with the PVC pipe which is more bent at the same load. The von Mises yield of the origami-based beam shaped structure 105 may be much higher than the state of the art PVC pipe.

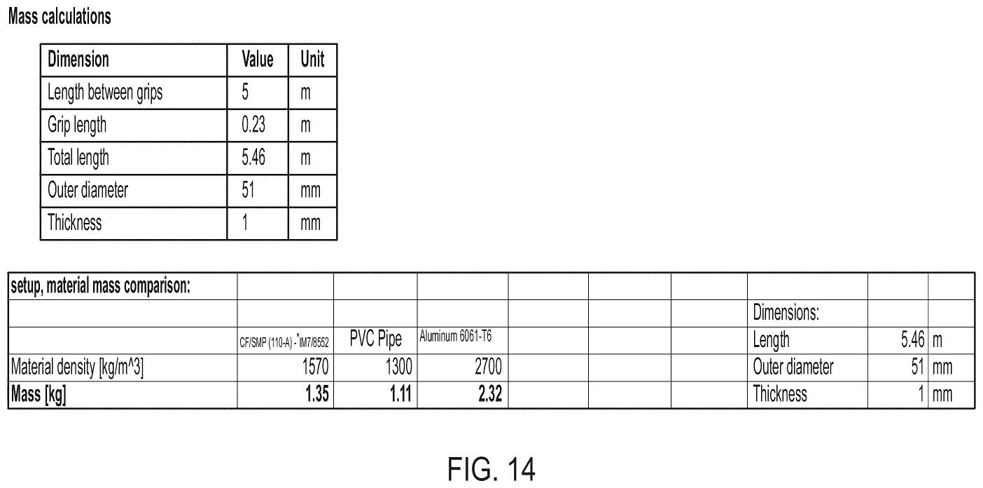

FIGS. 14-17 are comparisons of material conditions of the state-of-the-art beam structure versus a beam made of a composite according to the described examples. In an example, the material conditions may be at least one condition among conditions of shape, mass, density and packing efficiency. In FIGS. 14-17, a condition of a shape may be a cylinder shape to function as a beam for a structure.

With reference to FIGS. 14-16, in an example, for comparison purposes, target mechanical properties of the SMP 110-A and/or the UV curable polymer 110-B may be desired to be approximately comparable with mechanical properties of a not modified IM7/8552 (*IM7/8552) which is an example of a general epoxy from HEXCEL. In experimental tests, the SMP 110-A used as an example may be optimized using FEA modeling to be approximately comparable with mechanical properties of *IM7/8552. For example, the SMP 110-A after deployment may have a somewhat similar elastic modulus to *IM7/8552, based on mechanical properties of tensile strength based on force (stress) applied, stiffness based on deformation strain, after deployment of the SMP 110-A. However, in contrast to the SMP 110-A, *IM7/8552 may not be a shape memory polymer, and would not have any shaping temperature characteristics similar to the SMP 110-A, so that *IM7/8552 may only be used instead of SMP 110-A for experimental testing of elastic modulus of a target SMP according to the described examples versus the state of the art. In other words, *IM7/8552, or TEMBO EMC materials, are epoxy or cyanate ester materials, in which the Epoxy TEMBO (DP5.1, 5XQ) may have glass transition temperature (Tg) of 71˜77 degree ° C., which is too low to apply aerospace application under Sun, and Cynate ester TEMBO (BG1.3) may have a Tg of 164 degree ° C., which may be too high to save power for activation. In contrast to *IM7/8552, or TEMBO EMC materials, the polymer-based resin layer 110 may be conFIG.d to have Tg of about 100˜150 degree ° C. In an example, the polymer-based resin layer 110 has a shaping temperature of about 100° C. to about 150° C. to enable a shaping of the polymer-based resin layer 110.

In FIGS. 14-17, results are shown of analyzing material conditions of an origami-based beam shaped (also referred to has a hollow cylinder or a hollow beam structure) structure 105 made of a composite 100 according to the described examples versus a straight hollow cylinder made of PVC, Aluminum 6061-T6, or *IM7/8552.

FIG. 14 shows a design optimization of material conditions of mass and density of the state-of-the-art beam structures versus an origami based beam shaped structure 105 with a Yoshimura pattern. In FIG. 14, the material density of the CF/SMP 110-A at 1570 kg/m 3 and Mass of 1.35 kg, may be acceptable by being comparable to the state-of-the-art PVC pipe and Aluminum 6061-T6.

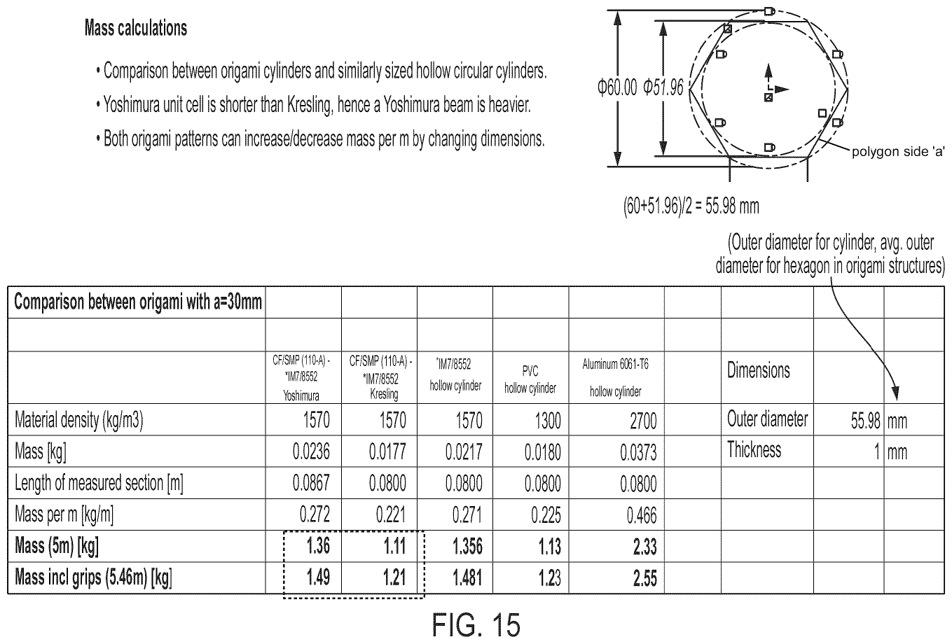

FIG. 15 shows a design optimization of material conditions of mass and density of the state-of-the-art beam structures versus origami based beam shaped structures 105 with a Yoshimura and Kresling patterns. A Yoshimura pattern may have a unit cell shorter than a Kresling pattern, so that a Yoshimura pattern beam may be heavier. In FIG. 15, the results in the dashed line box may indicate that for origami based beam shaped structures 105 of 5 m length and 5.46 m length with grips (FIG. 13A) with Yoshimura and Kresling patterns where a polygon side ‘a’ is 30 mm, mass and mass including grips in an application (FIG. 13A) of 1.36 kg and 1.49 kg (Yoshimura), and 1.11 kg and 1.21 kg (Kresling), respectively, may be acceptable by being comparable to the state of the art IM7/8552 hollow cylinder, PVC hollow cylinder and Aluminum 6061-T6 hollow cylinder. Both origami pattern beams may have increase or decrease mass per meter (m) by changing dimensions.

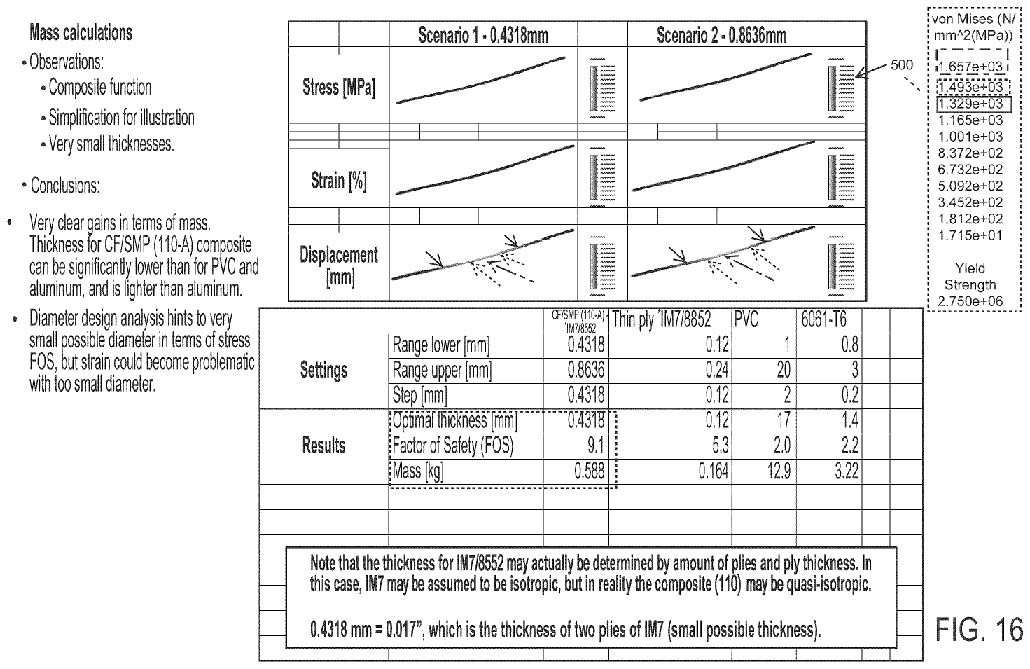

FIG. 16 shows factor of safety (FOS) results for an origami-based beam shaped structure 105 made of a composite 100 according to the described examples versus a straight hollow cylinder made of thin ply *IM7/8552, PVC, or Aluminum 6061-T6. In an example, a target FOS may be about 2 or higher, so that a thickness of a polymer-based resin layer 110, for example the SMP 110-A, may be optimized resulting in the FOS of about 2 or higher. As indicated in FIG. 16, the FOS for an origami based beam shaped structure 105 made of the SMP 110-A having a an example thickness of 0.4318 mm, which is a lower thickness than PVC, and subjected to von Mises stress 500, is at 9.1 FOS and 0.588 kg in mass, which FOS is well above the target FOS of 2 or more, and higher than the FOS of 5.3, 2.0 and 2.2 for thin ply *IM7/8552, PVC, or Aluminum 6061-T6, respectively.

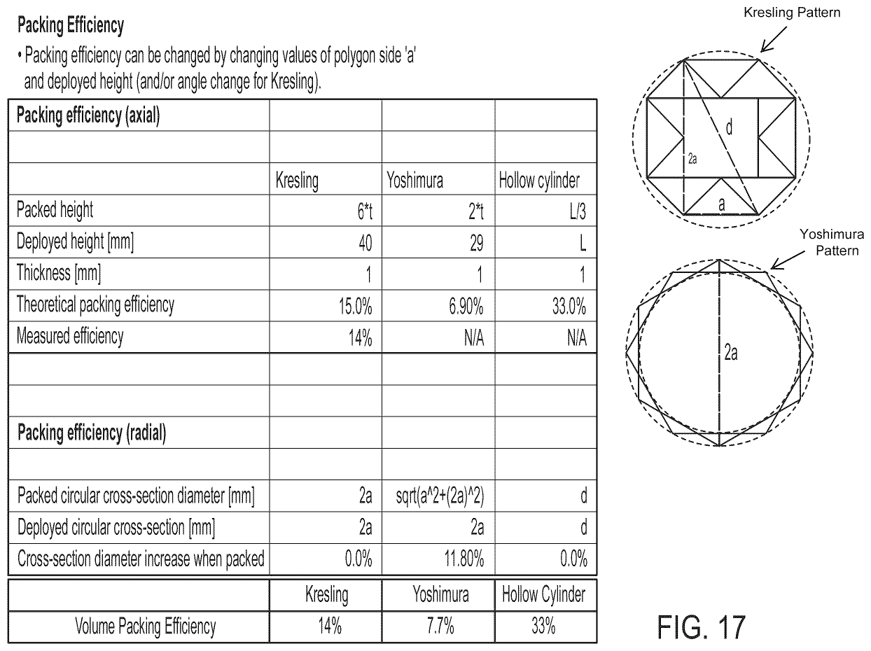

FIG. 17 is a comparison of material conditions of the state-of-the-art beam structure of a telescoping hollow cylinder versus an origami-based beam shaped structure 105 made of a composite 100, according to an example. In FIG. 17, the results are for a packing (also referred to as stowing) efficiency as a material condition. A telescoping hollow cylinder with three telescoping stages (FIG. 12) may have a packing efficiency of 33%. In case of an origami-based beam shaped structure 105 with a Kresling pattern, the packing efficiency of a packed height of 6*t may be 14%. The packing efficiency can be adjusted by changing dimensions of the polygon sides ‘a’, ‘2a’, and/or ‘d’ and height of the origami-based beam shaped structure 105.

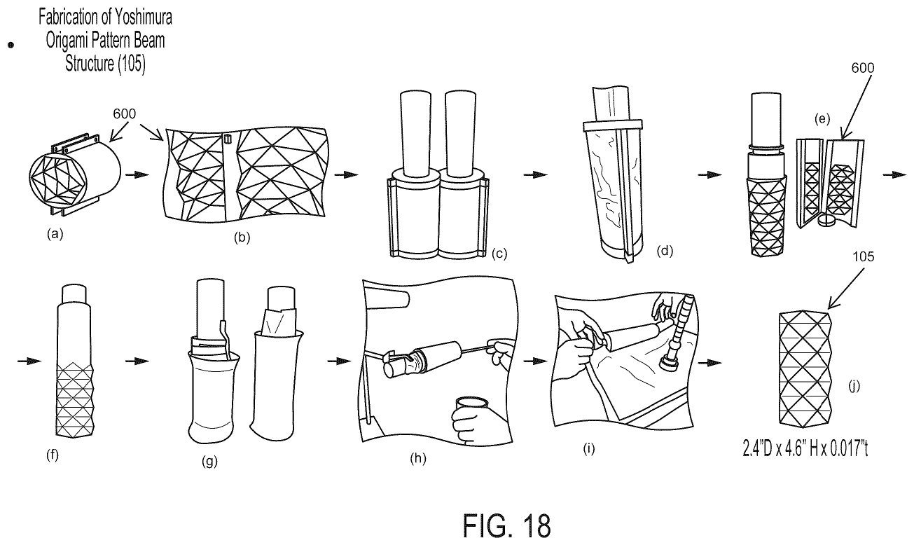

FIG. 18 is a diagram of a fabrication process of a composite, according to an example. In FIG. 18, at (a)-(d) a mold 600 of a Yoshimura origami pattern for an origami based beam shaped structure 105 made of a composite 100 may be used to mold the composite 100, resulting at (f)-(j) in an origami based beam shaped structure 105 according to an example.

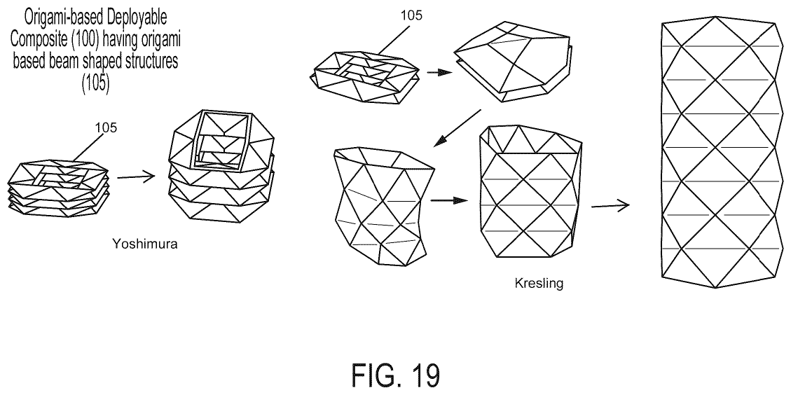

FIG. 19 is a diagram of a polyhedron pattern structure 105 made of a composite according to an example, in a collapsed (also referred to as stowed or packed) state and subsequent deployed state. In FIG. 19, the deploying of the pattern beam structure 105 is illustrated by arrows from the left side in a stowed state to the far-right side in the deployed state. In example, a method deployment of the composite 100 may be triggered to be activated by exposing the composite 100 to at least one heat source from among external direct heat, hot gas, electric heating tape, laser heating, infrared (ER) heating, ultrasonic wave, Joule heating with direct current, and inducting heating from alternative current and microwave. In an example, rigidity of the composite may be tested and/or timed to be controlled in response to the shaping stimulus, for example, by checking curing enthalpy in case of the UV curable polymer 110-B, and/or temperature in case of the SMP 110-A, while deploying the beam structure 105, using a measurement instrument or device. In an example, the measurement instrument or device may be implemented by software and/or computing hardware including at least one processor.

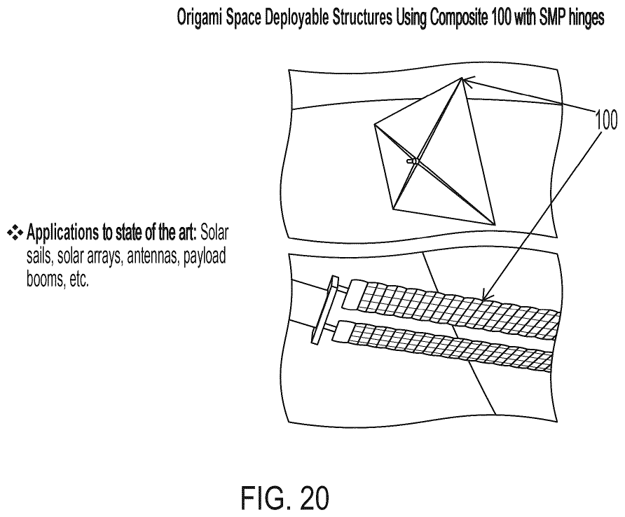

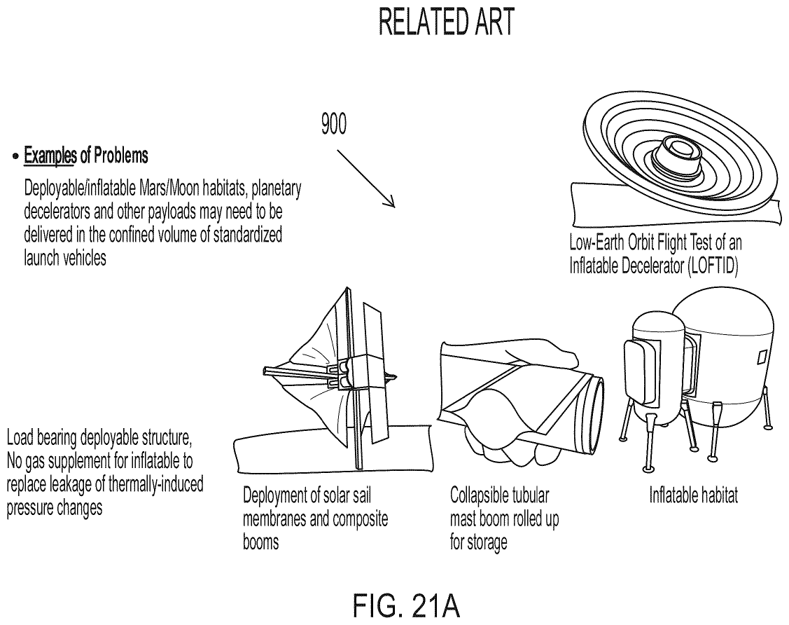

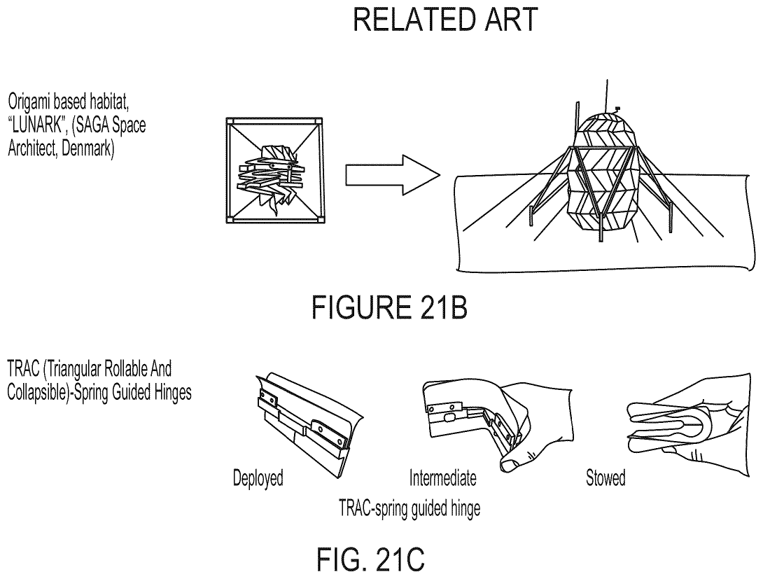

FIG. 20 is a diagram of examples of application of a composite according to the described examples, deployed into state-of-the-art structures.

For purposes of description herein, the terms “upper,” “lower,” “right,” “left,” “rear,” “front,” “vertical,” “horizontal,” and derivatives thereof shall relate to the examples as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise. The term “about” may include approximately a few measurement units more or less than a specified measurement unit.

The words “a,” “an” and “the” are intended to include plural forms of elements unless specifically referenced as a single element. The term “and/or” includes any one, or any combination, of items listed in association. The term “at least” preceding a listing of elements denotes any one or any combination of the elements in the listing. In other words, the expression “at least one of . . . ” when preceding a list of elements, modifies the entire list of elements and does not modify the individual elements of the list.

While this disclosure has been shown and described with reference to examples thereof, it will be understood by one of ordinary skill in the art that various changes in form and details may be made therein without departing from the scope as defined by the claims.

What is claimed is:

1. A composite comprising:
a polymer resin layer; and
a plurality of rigid plates reinforcing the polymer resin layer, each rigid plate of the plurality of rigid plates having a polygon shape with rigid sides,
the plurality of rigid plates fabricated in a pattern in the polymer resin layer forming a plurality of hinges in the polymer resin layer between sides of the plurality of rigid plates, so that the composite is foldable at the plurality of hinges into a collapsed state and expandable at the plurality of hinges to a deployed state.

2. The composite according to claim 1, wherein the polymer resin layer is a shape memory polymer (SMP) made of epoxy resin and at least one amine.

3. The composite according to claim 2, wherein:
the epoxy resin includes one or more of diglycidyl Ether of Bisphenol F; Bisphenol A diglycidyl ether; ARALDITE 506; Trifunctional epoxy; Triglycidyl Ether of p-Aminophenol; Tris(4-hydroxyphenyl)methane triglycidyl ether; Tetrafunctional epoxy; 4,4′-Methylenebis[N,N-bis(2,3-epoxypropyl)aniline]; and API 60; and
the at least one amine includes Benzhydrylamine, and one or more diamines from among 4, 4′-Diaminodiphenyl Sulfone, Diethyltoluenediamine, and Oxydianiline.

4. The composite according to claim 3, wherein the one or more diamines is about 1% to 99% in molar concentration of at the least one amine.

5. The composite according to claim 1, wherein the polymer resin layer is an ultraviolet (UV) curable polymer made of bisphenol-A epoxy diacrylate cured with about 20% by weight of a crosslinker of pentaerythritol tetraacrylyate or pentaerythritol triacrylate.

6. The composite according to claim 1, wherein the polymer resin layer has a shaping temperature of about 100° C. to about 160° C. to enable a shaping of the polymer resin layer.

7. The composite according to claim 1, wherein the polymer resin layer has a thickness of about 0.07 mm to about 50 mm.

8. The composite according to claim 2, wherein the shape memory polymer is reinforced with:
one or more of boron fiber (BF), KEVLAR, carbon fiber (CF), or a hybrid fiber of boron and polyamide; or
one or more of carbon nanotube (CT), boron nitride nanotube (BNNT), graphene nanosheet (GNS), ceramic nanoparticles, or metal nanoparticles.

9. The composite according claim 1, wherein at least one rigid plate of the plurality of rigid plates includes epoxy, bimaleimide, cyanate ester, or polyimide reinforced with at least one fiber material from among boron fiber (BF), KEVLAR, carbon fiber (CF), and a hybrid fiber of boron and polyamide.

10. The composite according claim 1, wherein at least one rigid plate of the plurality of rigid plates includes epoxy, bimaleimide, cyanate ester, or polyimide reinforced with one or more of carbon nanotube (CNT), boron nitride nanotube (BNNT), or graphene nanosheet (GNS).

11. The composite according to claim 1, wherein at least one rigid plate of the plurality of rigid plates includes epoxy, bimaleimide, cyanate ester, or polyimide reinforced with at least one fiber material that includes one or more of aramid fibers, boron fibers, glass fibers, polyethylene fibers, or metal fibers.

12. The composite according to claim 9, wherein the at least one fiber material has a form that includes one or more of a weaved fabric form, a non-woven fabric form, or unidirectional fibers form.

13. The composite according to claim 1, wherein at least one rigid plate of the plurality of rigid plates includes a ceramic material from among boron nitride, boron carbide, and silicon nitride.

14. The composite according to claim 13, wherein the pattern is at least one origami pattern from among origami patterns of Yoshimura and Kresling, and the composite forms a hollow beam structure when in the deployed state.

15. A structure, comprising:
a polymer resin layer; and
a plurality of rigid plates reinforcing the polymer resin layer, each rigid plate of the plurality of rigid plates having a polygon shape with rigid sides,
the plurality of rigid plates forming a pattern in the polymer resin layer, so that a plurality of hinges are formed in the polymer resin layer between sides of the plurality of rigid plates, resulting in the structure being foldable at the plurality of hinges into a collapse state and expandable at the plurality of hinges to deploy into the structure.

16. The structure according to claim 15, wherein,
the pattern is at least one origami pattern from among origami patterns of Yoshimura and Kresling, and
the structure is in a stowed state and deployable into a hollow beam structure from the stowed state.

17. The structure: according to claim 16, wherein,
the hollow beam structure is deployable in response to heat.

18. A method of activating shape change of a composite according to claim 1, the method comprising:
exposing the composite to at least one heat source from among an external direct heat, hot gas, electric heating tape, laser heating, infrared (IR) heating, ultrasonic wave, Joule heating with direct current, and inducting heating from alternative current and microwave.

19. The method according to claim 18, wherein the at least one heat source provides a heat flow in temperature range of about 100° C. to about 160° C. to enable a shaping of the polymer resin layer.
